(19) United States
(12) Patent Application Publication
(10) Pub. No.: US 2016/0229154 A1
(43) Pub. Date: Aug. 11, 2016

(54) TOUCH-SENSITIVE PANEL DEVICE AND ELECTRODE STRUCTURE THEREIN

(71) Applicant: J TOUCH CORPORATION, TAOYUAN COUNTY (TW)

(72) Inventors: YU-CHOU YEH, TAOYUAN COUNTY (TW); TSUNG-HER YEH, NEW TAIPEI CITY (TW); CHIU CHENG TSUI, TAOYUAN COUNTY (TW)

(21) Appl. No.: 15/130,203

(22) Filed: Apr. 15, 2016

Related U.S. Application Data
(62) Division of application No. 14/191,633, filed on Feb. 27, 2014.

(51) Int. Cl. B32B 15/04; G06F 3/041; B32B 7/12

(52) U.S. Cl. CPC B32B 15/04; B32B 7/12; G06F 3/041; B32B 2307/418; B32B 2307/41; B32B 2307/714; B32B 2457/208; G06F 2203/04112; G06F 2203/04103

(57) ABSTRACT

Disclosure is related to a touch-sensitive panel device and electrode structure therein. The electrode structure is made of metal material. The electrode structure not only eliminates reflective light from the metal layer, but also retain transmittancy and conductivity. The electrode includes a metal conductive layer, a light-trimmed roughened structure and a blackened layer. The trimmed roughened structure is formed in the electrode structure, for example on the metal conductive layer. The trimmed roughened structure is used to eliminate the reflective lights made by the metal conductive layer and the substrate. The trimmed roughened structure may be formed by an etching process applied to the metal conductive layer; or by electrolytic, sputtering, deposition or coating process. The blackened layer is used to absorb the lights reflected from the metal material, and also to reduce color shift of a display. The blackened layer is used to eliminate the metal reflection.

### CROSS-REFERENCE TO RELATED APPLICATIONS

This application is a Divisional application of U.S. patent application Ser. No. 14/191,633, filed on 27 Feb. 2014, and entitled TOUCH-SENSITIVE PANEL DEVICE AND ELECTRODE STRUCTURE THEREIN.

### BACKGROUND

1. Technical Field

The present invention generally relates to a touch-sensitive panel device and its electrode structure, and more particularly, to the electrode structure with anti-reflective function and the panel formed by the electrode structure.

2. Description of Related Art

Regarding the touch panel adopting electrode lines forming a metal mesh in the conventional technology, an extra anti-glare film should be incorporated for eliminating the metal reflective lights formed from the panel, which may result in poor display quality.

However, using conventional anti-glare film may thicken the touch-sensitive panel and then affect transmittance of the light-transmitting area. In the meantime, the optical plastic substrate itself may also cause reflective lights which may make visual fatigue to the human eyes. With worse reflective interferences caused by above mentioned situation, the metal lines would be much easier to be seen by naked eyes.

FIG. 1 schematically shows a cross-sectional structure of the electrode formed on the substrate of touch panel according to the conventional technology.

The touch-sensitive panel includes a substrate 10 with the top and bottom electrode structures 101 and 102. When fabricating the touch-sensitive panel, an optically-clear adhesive (OCA) 11 is set on the substrate 10. An anti-glare film 12 is adhered thereon to eliminate the reflective lights made by the metal materials. Then the touch-sensitive panel is adhered to the top substrate 14 via a further OCA 13 and set upon a LCD module 16 via OCA 15.

Some solutions used to reduce the metal reflection are already provided in the conventional technologies, for example a blackened layer is plated upon the metal grids. The blackened layer is used to adjust a chromatic aberration between the screen and grid structure. However, the blackened layer made by metal or oxide materials will decrease the conductivity of the adjacent metal layer, and have poor resistance to environmental corrosion.

The conventional stacked structure formed by conductive electrode and substrate in a touch-sensitive panel is depicted in the cross-sectional diagram shown in FIG. 2.

A plastic substrate 21 is shown within the panel. A first electrode layer 23 is formed on the top surface of the substrate 21. The electrode layer 23 is made of metal materials. The metal materials may cause metal reflection. A first blackened layer 25 is then formed on the surface of the electrode layer 23 for reducing the chromatic aberration between the metal layer and the screen. As shown in the diagram, while an incident light 201 irradiates the first electrode layer 23, the first blacken layer 25 reflects the lights as the reflective light 202. Similarly, the plastic substrate 21 reflects the incident light 203 and forms the reflective light 204.

Further, another electrode layer such as a second electrode layer 29 is formed upon the other side of the plastic substrate 21. A second blackened layer 27 is formed on an external surface of the second electrode layer 29. The diagram shows the lights passes through the substrate 21 and reaches the second electrode 29. The junction between the substrate 21 and the electrode layer 29 reflects the lights as the reflective light 205.

The foregoing description related to the conventional technologies shows whether using the anti-glare component to reduce the metal reflection or adopting the blackened layer to decrease the chromatic aberration, it can not effectively solve the metal reflection made by the electrode layer; instead, the additional structure increases the thickness of the panel, decreases the conductivity of the metal layer, and has poor resistance to corrosion.

### SUMMARY

Because the metal electrode lines in the conventional touch panel result in the metal reflection, an anti-glare film may be utilized to directly cover the metal lines for reducing the reflective lights. However, the anti-glare film may degrade quality of the panel display. Alternatively, the conventional technology incorporates a blackened layer not only to reduce the color shift between the electrode layer and the display, but also to decrease conductivity. It is featured that a touch-sensitive panel device, electrode structure, and a manufacturing method are provided in the disclosure. In addition to effectively reducing the reflective lights made by the metal electrodes or substrate, the electrode structure in accordance with the present invention also reduces thickness of the touch-sensitive panel without any influence of the display quality since it provides high transmittancy and conductivity. Further, the electrode structure has excellent weather resistance and corrosion resistance at high temperature and salt bath environment.

According to one embodiment, the main portions of the electrode structure are a metal conductive layer being an conductive structure of the electrode and formed on surface of the substrate; and a light-trimmed roughened structure formed on the metal conductive layer for scattering the metal reflection or the reflective lights from both the metal conductive layer and the substrate. The light-trimmed roughened structure is formed either by etching or machining the metal conductive layer, or by process of electrolytic process, sputtering, depositing, or coating. A blackened layer may also be introduced to the electrode structure in one further embodiment. The blackened layer is formed next to the light-trimmed roughened structure. The blackened layer may facilitate function of light trimming since it absorbs the lights emitted to the metal conductive layer. In the meantime, the blackened layer makes the incident light not to be reflected consistently at the same direction. Therefore, the metal reflection may be suppressed.

Based on the electrode structure mentioned above, the electrode structure in one further embodiment may include an adhesive layer. The electrode structure is combined with the substrate through this adhesive layer. The adhesive layer enhances adhesiveness between the electrode structure and the substrate. The adhesive layer may also be associated with a light-trimmed roughened structure.

According to one another embodiment depicting the electrode structure, a metal conductive layer and a blackened layer with roughened surface are included. The roughened surface of the blackened layer is made by etching or machining the blackened layer. The roughened surface scatters the reflective lights from the metal conductive layer, and also suppresses amount of the reflective lights. Similarly, an adhesive layer may also be disposed between the electrode structure and the substrate in this embodiment for enhancing adhesiveness. The adhesive layer may have its own light-trimmed roughened structure.

In the forgoing embodiment, one more blackened layer may be formed upon the existing blackened layer for reason to facilitate resistance of corrosion and blackening. One more adhesive layer may be added between the adhesive layer and the metal conductive layer. This added adhesive layer may be with light-trimmed roughened structure.

In one further embodiment of the electrode structure, the electrode structure includes an adhesive layer, a metal conductive layer, and a first blackened layer. The first blackened layer is formed on the metal conductive layer. The first blackened layer absorbs the lights emitted to the metal conductive layer for suppressing the reflective lights. A second blackened layer is formed on the first blackened layer. When etching or machining the surface of the second blackened layer so as to form the roughened surface structure, the effect to resist the reflective lights can be enhanced. The color shift between the substrate and the display can be reduced. Therefore, the electrode structure in the present embodiment includes, but not limited to, at least two adhesive layers, at least two blackened layers and light-trimmed roughened layers.

The electrode structure is fabricated with a substrate, and a touch-sensitive panel device is produced.

According to one further embodiment, the surface of substrate may be with a light-trimmed roughened structure. The roughened structure scatters the lights that entering the substrate. It effectively avoids the metal reflections and any visual discomfort that caused.

In one embodiment of the light-trimmed roughened structure formed within the electrode structure, an optically-clear adhesive (OCA) may be used in the structure as fabricating the structure. The optically-clear adhesive may fill up the gap of the light-trimmed roughened structure in a light-transmissive section. The OCA may decrease haze made by the light-trimmed roughened structure. The OCA may allow the blackened layer with surface texture to be darker, and suppress the color shift.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

FIG. 1 shows a schematic diagram depicting cross-sectional structure of a conventional touch-sensitive display;

FIG. 2 shows a schematic diagram depicting cross-sectional stacked structure of conductive electrode and substrate in a conventional touch-sensitive panel;

FIG. 3 shows a schematic diagram depicting a basic electrode structure in one embodiment of the present invention;

FIG. 4 shows another schematic diagram depicting another basic electrode structure in one embodiment of the present invention;

FIG. 5 shows one further diagram schematically depicting an electrode structure of the embodiment of the present invention;

FIG. 6A shows one diagram schematically depicting surface texture of substrate in one embodiment of the present invention;

FIG. 6B shows one more diagram schematically depicting surface texture of substrate in one embodiment of the present invention;

FIG. 7A shows a schematic diagram depicting combination of an electrode structure and a substrate in one embodiment of the present invention;

FIG. 7B shows another schematic diagram depicting combination of the electrode structure and the substrate in one embodiment of the present invention;

FIG. 8 shows a schematic diagram depicting a touch-sensitive panel in one embodiment of the present invention;

FIG. 9 through FIG. 11 schematically show the electrode structure in several embodiments of the present invention;

FIG. 12 shows a flow chart illustrating a process to manufacture the electrode structure according to one embodiment of the present invention.

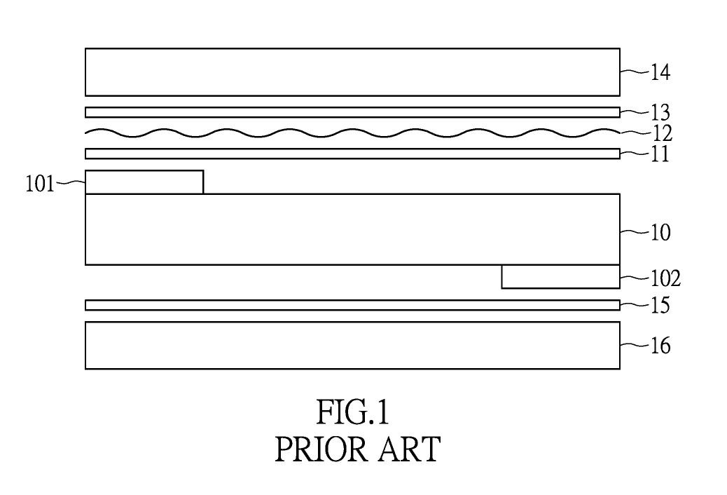

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

Disclosure in accordance with the present invention is related to a touch-sensitive panel device, an electrode structure, and a method for manufacturing the structure. The touch-sensitive panel utilizes electrode structure or conductive lines in metal or metal matrix composites. For eliminating the metal reflective lights made by the electrode structure having the metal structure or lines, a surface treatment process is applied to the metal materials so as to form a corrosion-resisting blackened layer. When the surface texture is incorporated to the electrode structure, it is thinner than the conventional anti-reflection lamination. Moreover, the disclosed electrode structure may also avoid the low conductivity problem caused by the conventional blackened structure. The touch-sensitive panel device therefore disposes the metal electrode lines with capability of anti-reflection. The panel also keeps the proper transmittancy and conductivity when it utilizes the metal electrode lines.

In the touch-sensitive panel device according to the embodiment of the present invention, a transparent substrate and the electrodes or conductive lines formed on the substrate are essentially included. The electrode structure is applicable to a touch-sensitive panel or a flexible touch-sensitive panel. In which, a light-trimmed roughened structure is formed upon surface of the metal. Alternatively, the light-trimmed roughened structure may be formed by etching or machining process. Moreover, the other manufacturing methods such as electrolytic process, sputtering and depositing for forming the roughened structure are not excluded. Furthermore, a blackened layer may be formed for either reducing energy of reflective lights, or optical matching and structural strengthening.

According to one embodiment of the present invention, the light-trimmed roughened structure formed upon the conductive metal or substrate is a thin layer. The thickness of the layer may be between 1 nm and 10 μm, and preferably between 50 nm and 2 μm. A blackened layer is formed after the conductive layer in order to suppress energy of reflective lights. It is characterized in that the blackened layer prefers brightness (L) with range of L<50; value of red-green (a) in a specific chromatic coordinates with range of a<−0.1; and value of yellow-blue (b) in a specific chromatic coordinates with range of b<−0.1.

### First Embodiment

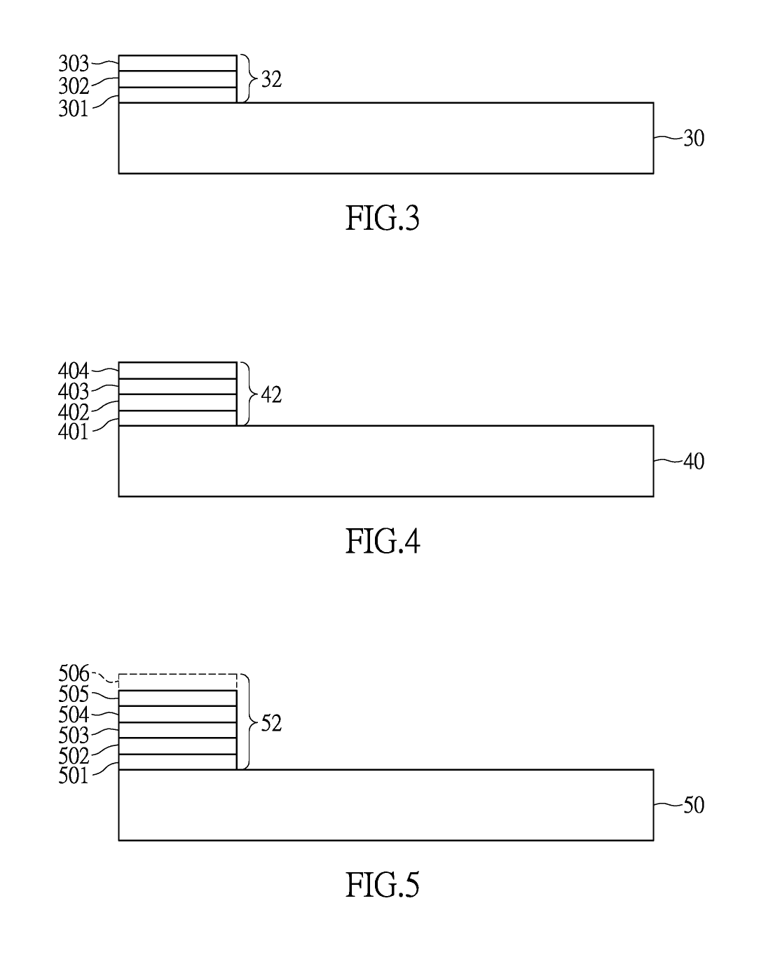

FIG. 3 shows a schematic diagram depicting a basic electrode structure in one embodiment of the present invention. An electrode structure 32 is formed on a substrate 30. The essential components of the electrode structure 32 include a metal conductive layer 301 being a conductive medium, a light-trimmed roughened layer 302, and a blackened layer 303. The feature of the structure and the process of making the structure may be referred to FIG. 4.

In the present embodiment, the electrode structure 32 may be directly formed onto a top and/or a bottom surface of a substrate 30. A metal conductive layer 301 as a main conductive structure within the electrode structure 32 may be formed onto a predetermined structure by means of electrolytic process, sputtering process, or imprinting process.

It is characterized in that the metal easily reflects the incident lights when it is as the main material of conductive structure. The reflective lights may affect visual sense when the metal conductive layer 301 is applied to a display. Thus a roughening means is introduced to the electrode structure. For example, one of the various means of roughening is such as a light-trimmed roughened layer 302 formed on surface of the metal conductive layer 301 according to one embodiment of the invention. The light-trimmed roughened layer 302 may be formed by performing a surface treatment onto the metal conductive layer 301. Alternatively, the light-trimmed roughened layer 302 may be formed by applying one roughened layer onto the metal conductive layer 301. The surface structure effectively scatters the reflective lights made by the metal conductive layer 301.

Next to the metal conductive layer 301 and the light-trimmed roughened layer 302, a blackened layer 303 is formed. The blackened layer 303 is formed within the electrode structure 32, for example, above the metal conductive layer 301. The blackened layer 303 is featured to absorb lights emitted to the electrode structure 32. The blackened layer 303 may also reduce color shift between the electrode structure 32 and the screen. Further, the blackened layer 303 may be as a protection to strengthen the electrode structure 32 and prevent corrosion.

### Second Embodiment

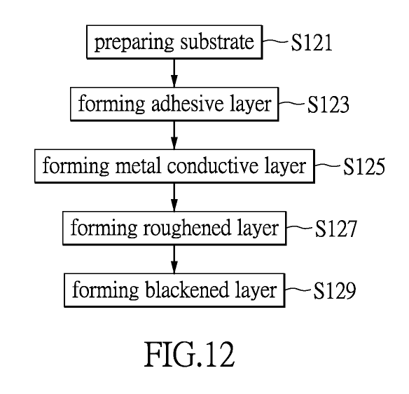

FIG. 4 shows a schematic diagram depicting the basic electrode structure within the touch-sensitive panel in one embodiment. The related process for manufacturing the electrode structure may be referred to the flow shown in FIG. 12.

In step S121 of FIG. 12, a substrate 40 is prepared. Metal is an essential material of the electrode structure 42 formed upon the substrate 40. The diagram shows an example of one electrode structure in the panel device. A plurality of electrode structure arranged in an array may be formed as demands. The shown substrate 40 includes a glass substrate or a plastic substrate adapted to a flexible touch-sensitive panel. The plastic substrate may be made of PET (Polyethylene terephthalate), PEI (Polyetherimide), PPSU (Polyphenylensulfon), PI (Polyimide), or in combination thereof.

The electrode structure 42 has an adhesive layer 401 adjacent to the substrate 40. The adhesive layer 401 is firstly formed on surface of the substrate 40, as described in step S123 of FIG. 12. An electrode structure 42 is then combined with the substrate 40 through the adhesive layer 401. The adhesive layer 401 preferably enhances the adhesiveness between the electrode structure and the substrate 40. Additional adhesive layer may also be added to strengthen the combination according to another embodiment. Next, a metal conductive layer 402 is then formed upon the adhesive layer 401 in step S125 of FIG. 12. This metal conductive layer 402 acts as a main conductive structure for the electrode structure 42. The metal conductive layer 402 may be made by process of electrolytic, sputtering, or imprinting onto a predetermined structure. Material of the metal conductive layer 402 is such as silver, copper, or the like.

In one further embodiment, a blackened layer 404 is utilized to reduce color shift of the display, or suppress reflective lights made by the metal conductive layer 402 in a display panel. The blackened layer 404 is formed onto the metal conductive layer 402 by process of electrolytic, sputtering, depositing, or coating in step S129 of FIG. 12. The blackened layer 404 is able to strengthen the structure and resist corrosion in addition to reducing color shift and reflective lights of the display.

Furthermore, a light-trimmed roughened layer 403 may be formed, such as step S127 of FIG. 12, onto the surface of the metal conductive layer 402 before the above-mentioned blackened layer 404 is formed. This light-trimmed roughened layer 403 is such as a light-trimmed roughened structure which undergoes a surface treatment, e.g. texturization. For example, the surface texture may be made by etching or machining the surface of metal conductive layer 402. Additional roughened structure layer may be formed directly onto the metal conductive layer 402 by performing electrolytic process, sputtering, or depositing. The surface texture scatters the reflective lights made by the metal conductive layer 402, or suppresses the reflective lights simultaneously caused by the metal conductive layer 402 and the substrate 40.

Consequently, the blackened layer 404 is formed on the light-trimmed roughened layer 403. This blackened layer 404 is such as an additional blackened layer formed by process of electrolytic, sputtering, depositing, or coating. This continuous non-planar structure formed on the metal conductive layer 402 is utilized to scatter and absorb the lights emitted to the metal conductive layer 402. Therefore the metal reflection can be suppressed. Further, the continuous non-planar structure may simultaneously keep the conductivity from declining since the structure is able to increase probability of electron tunneling. Still further, the structure is as a protective layer for corrosion resistance since it has better bonding strength and hardness than the metal conductor. The blackened layer 404 may also be an auxiliary structure to define the appearance of the metal electrode when it is an exterior layer of the electrode structure 42.

Still further, in accordance with one embodiment, an optically-clear adhesive (OCA) is used to combine the electrode structure 42 with the upper components of the touch-sensitive panel device such as the upper membranes and substrate and/or lower membranes and display module. While the optically-clear adhesive is adhered to the upmost blackened layer 404 of the electrode structure 42 in this embodiment, the OCA allows the blackened layer 404 to be much blackened and with higher contrast ratio according to its characteristics. Therefore, the OCA may decrease mist interference made by the roughened structure. As a whole, the OCA is utilized for the display to provide a comfortable visual experience.

### Third Embodiment

The electrode structure according to one further embodiment of the present invention is referred to FIG. 5. The schematic diagram shows an electrode structure 52 formed on a substrate 50. The substrate 50 is prepared as the transparent material such as plastic or glass material. The main components of the electrode structure 52 include a first adhesive layer 501 adhering the substrate 50 to the electrode structure 52. This first adhesive layer 501 is able to strengthen the adhesiveness between the electrode structure 52 and the substrate 50. Another adhesive layer (the second) may be added onto the first adhesive layer 501. Such second adhesive layer 502 may further enhance the adhesiveness for the following metal conductive layer, the substrate 50, and the first adhesive layer 501.

Next, a metal conductive layer 503 is formed onto the second adhesive layer 502. The metal conductive layer 503 is as a conductive layer for the electrode structure. The related material is such as silver or copper, but not excluding the other conductive materials. According to the present embodiment, when etching the surface of the metal conductive layer 503, a light-trimmed roughened layer 504 is formed. The light-trimmed roughened layer 504 may also be an additional layer upon the metal conductive layer 503 by performing electrolytic process, sputtering or depositing. The light-trimmed roughened layer 504 allows scattering the lights reached to its surface texture and eliminating the consistent reflective lights.

The various metal materials for the metal conductive layer 503 easily reflect the incident lights, and also decline the conductivity because of the oxide substance. Thus a first blackened layer 505 may be necessarily prepared for the light-trimmed roughened layer 504 to corrosion resistance. The first blackened layer 505 is a black substance or other material with deep color for effectively reducing the metal reflection and the color shift of the display. Furthermore, the first blackened layer may be made of metal-based material. The metal blackened layer may keep the conductivity of the electrode structure 52. The blackened layer may provide better corrosion resistance than the metal conductive layer 503 or other components within the electrode structure. The blackened layer is as a covering structure for the electrode structure and as an auxiliary layer for defining the appearance of the electrode structure.

In addition to the above-mentioned layers within the electrode structure, one further stacked type of blackened layer is formed upon the first blackened layer 505, for example the second blackened layer 506. The second blackened layer 506 may provide the similar function of corrosion resistance and no-loss conductivity. Further, the second blackened layer 506 may enhance chromaticity of black. The roughened structure may further decrease the reflectivity of the surface.

Through the optical matching made in combination of the foregoing adhesive layer, light-trimmed roughened structure, and blackened layer, the electrode structure with low reflectivity or without reflectivity is formed. The electrode structure renders a comfortable visual environment for the people to watch the content on the display without surrounding influence from poor light.

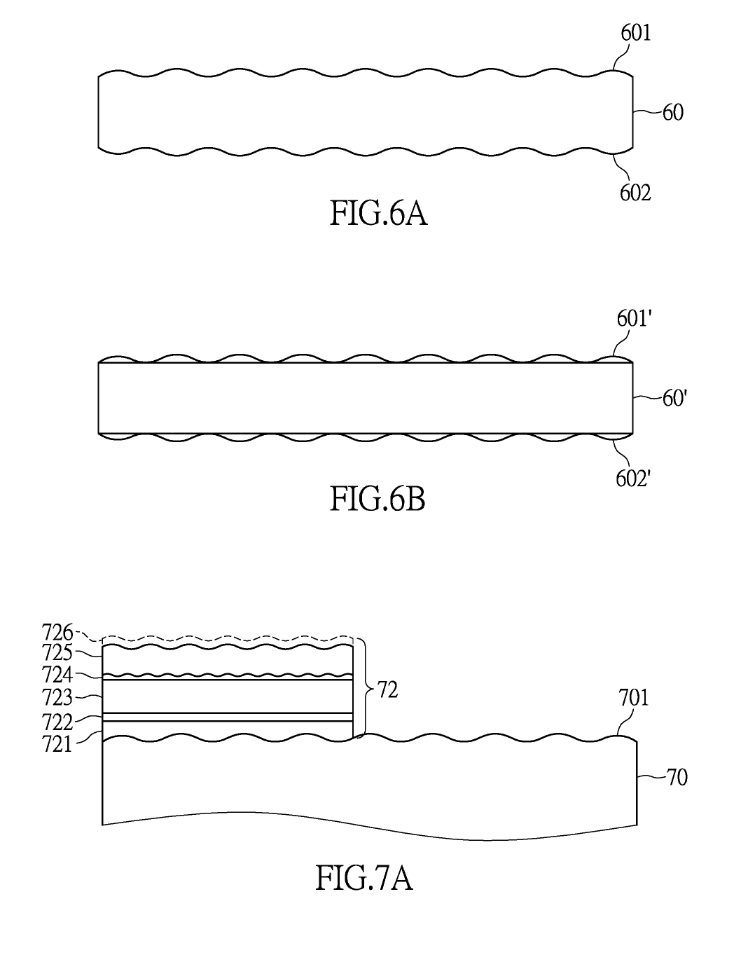

As a whole, the blackened layer within the electrode structure effectively reduces the metal reflection, and the color shift of display; the light-trimmed roughened structure is able to reduce internal or external reflective lights. The top and bottom surfaces of the substrate may be equipped with the light-trimmed roughened structure shown in FIG. 6. It is able to enhance the comfortness of visual experience when the electrode structure is applied to the touch-sensitive panel.

### Fourth Embodiment

The mentioned light-trimmed roughened structure is formed upon the substrate. As shown in FIG. 6A, the light-trimmed roughened structures 601, 602 may be formed on the surface of substrate 60 by performing the surface treatment. The process is such as etching or surface machining. More specifically, the light-trimmed roughened structures 601, 602 are formed by etching process using sulfuric acid or permanganate, mechanical physical method, or plasma cleaning process using roll-forming, ion beam, electrical corona, or atmospheric plasma. The light-trimmed roughened structures 601, 602 in the current embodiment have the same material with the substrate.

When the electrode structure is formed on the substrate 60, the light-trimmed roughened structure renders the incident lights non-consistently directed to the same direction for reducing the reflective lights. The reflective lights to the substrate 60 can be immediately reduced.

FIG. 6B shows a schematic diagram depicting the surface structure of the substrate 60′ for reducing the reflective lights. A first light-trimmed roughened layer 601′ is formed upon the top surface of substrate 60′. One of the objectives of the light-trimmed roughened structure is to reduce the reflective lights made by the whole substrate 60′. The light-trimmed roughened layers 601′, 602′ may be the additional structure formed thereon, for example made by electrolytic, sputtering, coating, imprint, or depositing process performed to the surface.

The bottom surface of the substrate 60′ may be formed with a second light-trimmed roughened layer 602′. The process for forming the second light-trimmed roughened layer 602′ is such as the foregoing method for the first light-trimmed roughened layer 601′. With the disposal of both the first light-trimmed roughened layer 601′ and the second light-trimmed roughened layer 602′ on the substrate 60′, the reflective lights made by the external lights emitted to the structure and the internal lights affecting the visual comfortness from the backlit module can be effectively reduced. It is noted that the backlight emitted from the backlit module easily results in moire interference when it passes through the black matrix of color filter and metal electrodes. The first or second light-trimmed roughened layer is utilized to destroy the consistent backlight as passing through the black matrix for eliminating the moire. When disposing the light-trimmed roughened structure on the substrate, it effectively reduces the thickness of the components within the electrode structure, and eliminates the metal reflection, and moire interference.

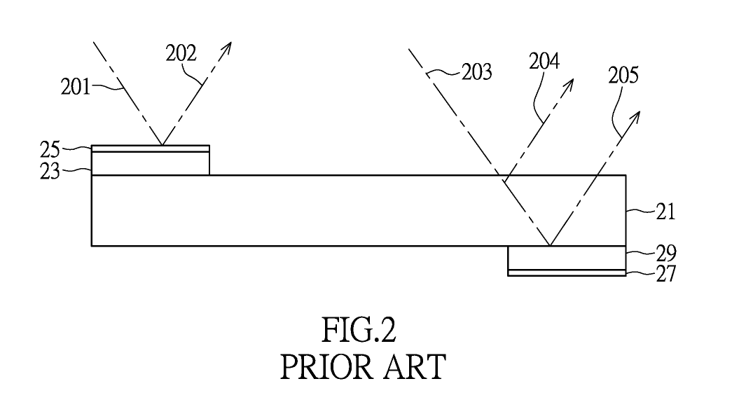

The following description of the design of the panel device may be in view of the diagram illustrating the incident and reflected lights shown in FIG. 2. The second light-trimmed roughened layer 602′ over the surface of substrate 60′ is engaged with the electrode structure located at the lower surface of the substrate 60′. The second light-trimmed roughened layer 602′ as a whole effectively eliminates the metal reflection also because the lights reaching the lower surface of the substrate 60′ is reduced.

The first light-trimmed roughened layer 601′ and the second light-trimmed roughened layer 602′ may be made by additionally coating an ultraviolet glue or organic-inorganic silicone resin to form a hardened layer. However, this method makes the light-trimmed roughened layer have different material form the substrate.

The light-trimmed roughened structures 601, 602 shown in FIG. 6A, and the first light-trimmed roughened layer 601′ and the second light-trimmed roughened layer 602′ according to the present embodiment may have a roughness such as center line average roughness (Ra) ranged between 0.001 um and 0.2 um, and preferably Ra=0.02-0.1 um.

### Fifth Embodiment

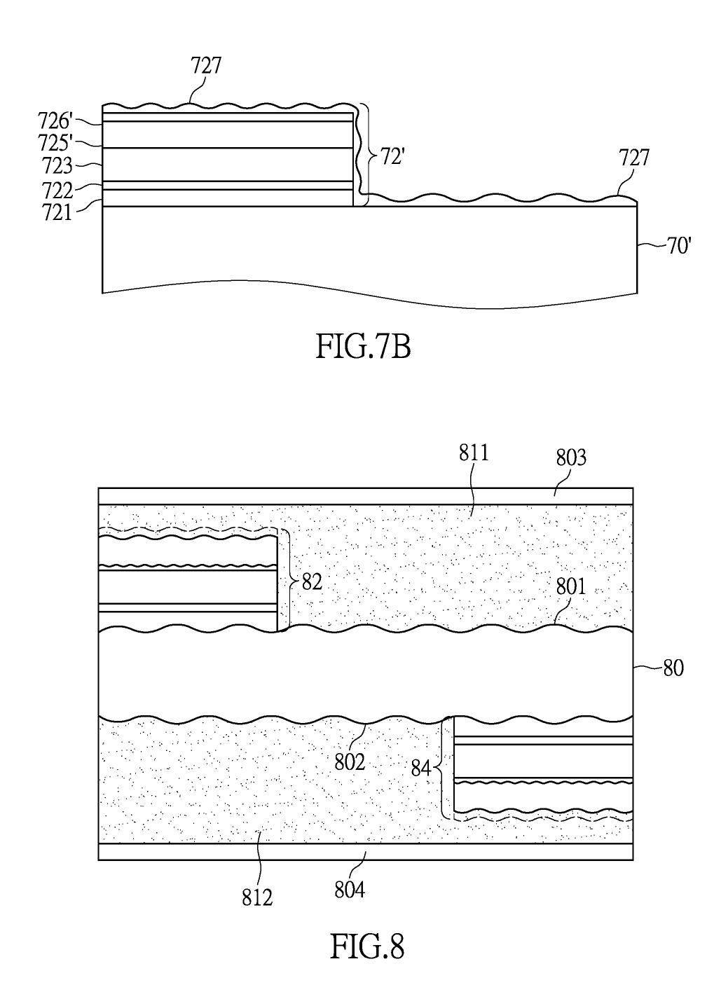

FIG. 7A shows a schematic diagram depicting an electrode structure 72 and a substrate 70 with a light-trimmed roughened structure 701.

The electrode structure 72 is as a stacked structure formed onto the substrate 70. The main components of the electrode structure 72 include a first adhesive layer 721 engaged with the substrate 70. The surface of substrate 70 for the engagement may be formed with the light-trimmed roughened structure shown in FIG. 6 such as the light-trimmed roughened layer 701 in the current example.

Furthermore, another adhesive layer may be formed onto the first adhesive layer 721, such as the second adhesive layer 722. The second adhesive layer 722 is an auxiliary structure to combine the next metal conductive layer 723. The metal conductive layer 723 may be formed based on the above-mentioned methods. For reducing or eliminating the metal reflection made by this metal conductive layer 723, a further light-trimmed roughened layer 724 is formed on the metal conductive layer 723 within the electrode structure 72. Still further, a first blackened layer 725 is formed for corrosion resistance and blackening effect. For further reducing the color shift of display, another blackened layer such as the shown second blackened layer 726 is formed onto the first blackened layer 725. The second blackened layer 726 also enhances the capability of corrosion resistance and blackening.

When the exterior surface of the electrode structure is formed with a light-trimmed roughened or blackened structure within the stacked structure, the reflective lights made by the substrate 70 or metal conductive layer 723 can be effectively reduced or completely eliminated. In the meantime, the color shift of display can be improved.

### Sixth Embodiment

In FIG. 7B, the light-trimmed roughened structure, for example 724 of FIG. 7A, can be formed simultaneously on both the substrate and electrode structure at the last processing. Other than the step of machining, according to one embodiment, additional ultraviolet glue or organic-inorganic silicone resin may be coated as a hardened light-trimmed roughened structure on the surface of the substrate and electrode structure. The coating process allows the light-trimmed roughened layer having different material from the electrode and substrate. The process for forming the light-trimmed roughened structure is such as process of electrolytic, sputtering, coating, imprint, or depositing.

As FIG. 7B shows, the electrode structure 72′ formed on the substrate 70′ has no light-trimmed roughened layer 724 formed on the metal conductive layer 723 shown in FIG. 7A. The light-trimmed roughened layer (701 of FIG. 7A) may not be necessarily formed on the substrate 70′ in the beginning. The light-trimmed roughened structure 727 may be simultaneously formed over the substrate 70′ and the electrode structure 72′ in the last machining step after forming the first blackened layer 725′ or adding the second blackened layer 726′

For the examples shown in FIG. 7A or FIG. 7B, the first adhesive layer 721 and/or the second adhesive layer 722 may be made of polymer, oxide, metal material, or in combination thereof. More specifically, the polymer within the first adhesive layer 721 may improve the adhesiveness between the first adhesive layer 721 and the substrate 70. The oxide material in the first adhesive layer 721 and/or the second adhesive layer 722 allows the adhesive layer(s) to be with features of anti-reflection, anti-interference, anti-rainbow pattern, wear resistance, and scratch resistance. The metal material of the first adhesive layer 721 enhances adhesiveness of the first adhesive layer 721 and the second adhesive layer 722.

The materials adopted in the stacked structure may be polymer such as acrylic, PET, PEI, PPSU, PI, PEDOT, Polyaniline, Polypyrrole or the composite material in combination thereof. The oxide may be amorphous or polycrystal oxide film or powder. The oxide may be made of titanium oxide, tantalum oxide, silicon oxide, aluminum oxide, or the composite material in combination thereof. The metal may be copper, silver, aluminum, molybdenum, nickel, chromium, tungsten, titanium, silicon, zinc, tin, iron or composite material in combination thereof. The stacked structure may be in combination of two or three materials of polymer, metal, and oxide. The composite material may be in combination of metal and oxide, polymer and metal, polymer and oxide, or metal, oxide and polymer. The proportion of polymer in the composite material is around 10-90%. The proportion of oxide in the composite material is around 10-90%. The proportion of metal is around 10-90%. The oxide may also be stacked structure.

In one further embodiment, the thickness of the Titanic oxide is around 900 nm. The thickness of silicon oxide is around 100 nm. The thickness of the first adhesive layer 721 and/or the second adhesive layer 722 is preferably between 0.001 um and 1 um. The reflectivity of the first adhesive layer 721 and/or second adhesive layer 722 is between 1% and 50%, and preferably lower than 30%. It is noted that the first adhesive layer 721 and/or the second adhesive layer 722 undergoes a machining process so as to form roughened structure for reducing the reflective lights.

It is noted that the method for forming the first adhesive layer 721 and/or the second adhesive layer 722 is such as (1) strengthening the sputtering energy to bombard the material of adhesive layer into the substrate; (2) adding color polymer such as Polyaniline into the adhesive layer; or (3) etching the material of adhesive layer to form porous structure.

The metal conductive layer 723 may be made of copper, gold, silver, aluminum, tungsten, iron, nickel, chromium, titanium, molybdenum, indium, tin, or the composite material in combination thereof. The thickness of the metal conductive layer 723 is preferably around 0.001 um to 5 um.

For increasing adhesiveness and conductivity, the electrode structure 72 could be a graduated structure for that when the metal conductive layer 723 is made of pure metal, the adjacent second adhesive layer 722 may have content of the pure metal more than 50%, and the first adhesive layer 721 includes content of pure metal less than 50%. For example, while the conductive layer 723 is pure copper, the first adhesive layer 721 may be nickel-copper-chromium-iron alloy. The proportion of compositions of nickel, copper, chromium and iron in the alloy is 60:30:10:0; or 80:10:5:5. The first adhesive layer 721 may also be nickel-tungsten alloy, and its proportion of nickel and tungsten is 50:50. Further, the first adhesive layer 721 may be additionally added with silicon and phosphorus. The second adhesive layer 722 may be copper-nickel-chromium alloy, and its proportion of copper, nickel and chromium is 60:30:10. The second adhesive layer 722 may also be copper-nickel-tungsten alloy, and its proportion is 60:20:20. Further, The second adhesive layer 722 may also be added with silicon and phosphorus.

The light-trimmed roughened layer 724 within the electrode structure 72 is a light-trimmed roughened structure which is formed in a destructive way to increase the surface roughness by mechanical physical roughening process such as roll-forming or plasma etching, or chemical etching process. The layer has the same material with the metal conductive layer 723.

The light-trimmed roughened layer is referred the component 724 of FIG. 7A. The light-trimmed roughened layer 724 is configured to be extended until the metal conductive layer 723 is fully covered. The light-trimmed roughened layer 724 may have different material from the metal conductive layer 723. The roughened layer 724 may be made by (1) modifying condition of coating process, including dry-coating such as sputtering or evaporation, or wet-coating such as electroplating or chemical plating, and the light-trimmed roughened layer 724 is plated to be non-continuous island-distributed roughened surface or porous structure; or (2) flattening the light-trimmed roughened layer 724 in a destructive way to increase its surface roughness by mechanical physical roughening process such as roll-forming, plasma etching, or chemical etching. The light-trimmed roughened layer 724 may be made of polymer, oxide, or metal when it is formed in the configuration of extension. The layer 724 may have the same material with the metal conductive layer 723; or the same with the first blackened layer 725.

The light-trimmed roughened layer 724 renders the surface roughness of the electrode structure 72. The layer 724 allows the electrode structure 72 to be with ability of anti-reflection, adhering photo-enabled or thermal-enabled anticorrosive agent to the surface. Therefore, the touch-sensitive panel with the electrode structure 72 is not necessary to dispose an additional anti-glare film. The method allows reducing cost without affecting the etching process upon the fine lines. The roughness (Ra) of the light-trimmed roughened layer 724 is ranged between 0.001 um and 0.2 um. The preferred roughness (Ra) is around 0.02 um to 0.1 um. A haze should therefore be smaller than 2.

The mentioned first and/or second blackened layers 725, 726 may be made of copper, silver, aluminum, molybdenum, nickel, chromium, tungsten, titanium, silicon, zinc, tin, iron, or in combination thereof. The thickness of the first blackened layer 725 and/or second blackened layer 726 is around 0.001 um to 1 um. The reflectivity of the first blackened layer 725 and/or second blackened layer 726 is around 1% to 50%, and preferably lower than 30%.

The second blackened layer 726 is such as another blackened layer which covers the first blackened layer 725. The second blackened layer 726 improves the capability of corrosion resistance and blackening. The whole structure may therefore have enhanced environmental adaptability. The second blackened layer 726 assists the first blackened layer 725 to improve the chromaticity of black and capability of reflection. It is noted that the second blackened layer 726 may be made of oxide, polymer, carbon, or their mixture. The oxide is such as silicon oxide, titanium oxide, aluminum oxide, or their mixture. The polymer is such as a mixture of acrylic and alkylbenzimidazole, alkyl-benzene compound, PET, or color-organic matter such as PEDOT, Polyphenylamine, or their mixture.

In the mixture of second blackened layer 726, the proportion of polymer in the mixture is 10-90%, and oxide in the mixture is 10-90%. The thickness of the second blackened layer 726 is preferably 0.001 um to 1 um. The reflectivity of the second blackened layer 726 is around 1% to 50%, and preferably lower than 30%. An overall reflectivity of the first blackened layer 725 and the second blackened layer 726 should be lower than 30%. For example, while the panel device is applied to a display, the reflectivity is lower than 30%, a/−a axis of chromatic coordinates is lower than −2, b/−b axis of chromatic coordinates is lower than −4 when the backlight of display is shut down. When a polarizer is applied to a display, the chromaticity may be shifted to blue-green, and the polarizer allows the display to have b=−7.

The first blackened layer 725 may simultaneously adjust the color of the metal lines for matching the color of the metal itself. For example, the base of pure copper has reflectivity larger than 50% with L>90%, a<0.1, and b>2. The first blackened layer 725 allows the display to approach the color of Black matrix (BM), and reduce the contrast chromatic aberration.

It is noted that the human eyes easily see the yellow-shifted metal reflection if the value of b is larger than 1, or reflectivity larger than 50%. The chromaticity of the first and/or second blackened layer 725, 726 may be changed when the thickness of the material is changed. The disposal of second blackened layer 726 is able to modify chromaticity of the first blackened layer 725 to be covered and make it approach the color of the Black matrix of display. The blackened layer also assists the structure to have capability of resisting color shift, anti-reflection, anti-moire interference, anti-rainbow pattern, wear resistance, and scratch resistance.

The disclosure related to the electrode structure with roughened structure described may be one of the embodiments of the present invention, but not limit the scope of the present invention.

### Seventh Embodiment

The further embodiment is described in FIG. 8 which shows a schematic diagram of the assembly of substrate and electrode structure applied to a touch-sensitive panel.

In addition to the substrate having a surface with light-trimmed roughened structure according to one of the embodiments, both the top and bottom surfaces of the substrate 80 in accordance with the present invention are equipped with light-trimmed roughened structures. For example, the first light-trimmed roughened layer 801 and second light-trimmed roughened layer 802 may be formed by the process of chemical etching using sulfuric acid or permanganate, mechanical physical process such as roll-forming, plasma cleaning using ion beam, electrical corona, or atmospheric plasma.

The first electrode structure 82 formed on the first light-trimmed roughened layer 801 on top surface of the substrate 80 has the same structure with the second electrode structure 84 located below. The related description is referred to FIG. 7A or FIG. 7B. The structure within the first electrode structure 82 and the second electrode structure 84 is given with functions such as resistance of color shift, anti-corrosion, anti-moire interference, anti-rainbow pattern, wear resistance, and scratch resistance. The structure at least includes adhesive layer, blackened layer, and light-trimmed roughened structure. Reference is made to FIG. 7A or FIG. 7B.

A first light-trimmed roughened layer 801 is formed on an external surface of substrate 80 for the purpose of anti-reflection. The second light-trimmed roughened layer 802 is utilized to reduce or prevent the metal reflection made by the second electrode structure 84. Since the metal reflection can be effectively reduced, the visual effect is significantly improved. Therefore, the electrode structure in accordance with the present invention provides great comfort for the human eyes, effectively reduces the thickness of the structure, and suppresses moire interference.

The touch-sensitive panel device constituting the display is assembled of substrate 80 and electrode structures 82, 84. As the diagram shows, optically-clear adhesives 811, 812 are as the adhesive agent. For example, the substrate 80 and electrode structures 82, 84 in the touch-sensitive panel device are assembled with the top optical components via optically-clear adhesive 811. The figure shows the assembly of transparent substrate 803 and other optical components is combined with an LCD module 804 through optically-clear adhesive 812. When the light-trimmed roughened structure formed on the surface of the assembly of substrate 80 and electrode structures 82, 84 is combined with other components, the optically-clear adhesives 811, 812 are filled in. The optically-clear adhesives 811, 812 may fill up the gaps of the surface roughened structure to decrease the haze while roughening the light-transmissive section of the device. The light transmittance of the light-transmissive section may be improved.

The optically-clear adhesives 811, 812 fill up the gaps formed by incorporating the first light-trimmed roughened layer 801 and the second light-trimmed roughened layer 802, so as to decrease the haze of the light-transmissive section. Furthermore, the material of the optically-clear adhesives 811, 812 is similar with the substrate 80 and has smaller refractive difference. In addition to increasing light transmittance of light-transmissive section of the substrate 80 while filling up the roughened surface, the OCA also allows the blackened layer with anti-corrosion to approach pure black in chromaticity, or reach similar chromaticity with the Black matrix of display. The OCA therefore reduces the haze. The OCA will not affect the function of light-trimmed roughened layer. The comfort of human eyes is improved while the blackened layer effectively shields the metal mesh.

It is noting that rather than plating film such as anti-reflection film with lower refractivity onto the substrate in the conventional technology, an optically-clear adhesive is applied for improving light transmittance. The OCA fills up the gap caused by the roughened structure when roughening the substrate, also decreases haze. For example, since the refractivity of the OCA and the glass of the panel device is lower than the PET substrate, the light transmittance can be improved. The experimental data shows the refractivity of surface glass is around 1.53; refractivity of optically-clear adhesive is around 1.46-1.47; and refractivity of PET substrate is around 1.62.

The embodiments of the electrode structure may not be limited to the above description. The followings also show the other embodiments of the electrode structure. The materials of the adhesive layer, metal conductive layer, light-trimmed roughened layer, and the blackened layer, method for manufacturing the same, and the related stacked structure may still be referred to the above embodiments.

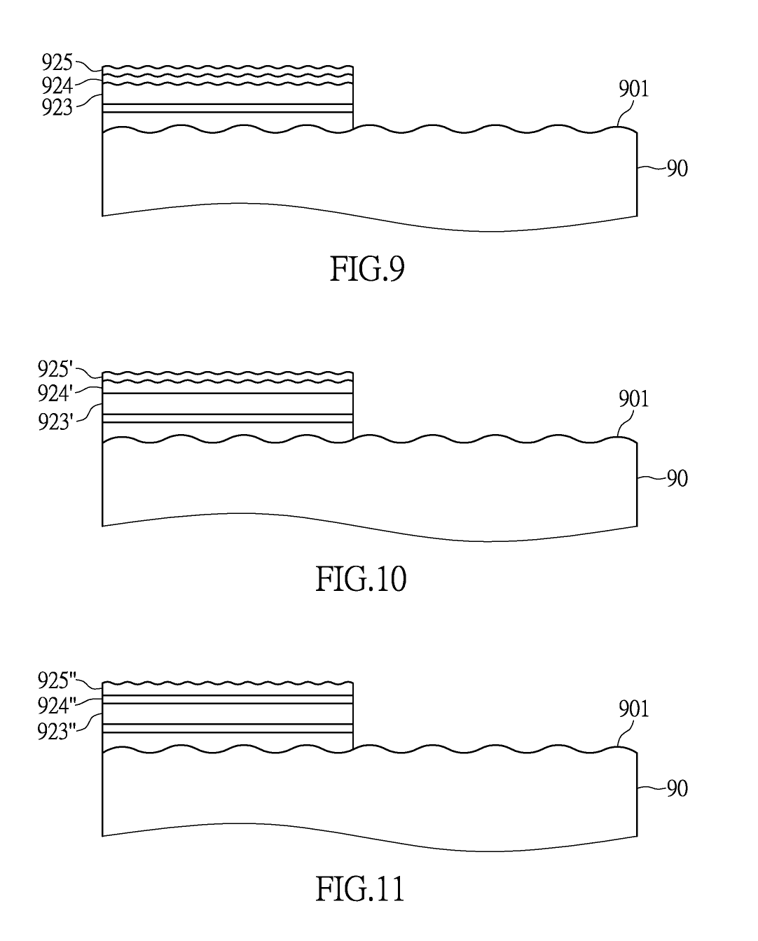

FIG. 9 shows a schematic diagram depicting the electrode structure formed on a substrate in one of the embodiments. The diagram shows a light-trimmed roughened structure formed as a light-trimmed roughened layer 901 on the substrate 90 for reducing the reflective lights. The main components of the electrode structure are, but not limited to, referred to the description of FIGS. 7A, 7B and 8. The light-trimmed roughened structure is formed by directly etching or machining the metal conductive layer 923. When the light-trimmed roughened layer is formed, the following structure may therefore be shaped as the roughened texture. For example, the surface structure of first blackened layer 924 and second blackened layer 925 are shaped with the light-trimmed roughened structure of the metal conductive layer 923.

FIG. 10 shows the electrode structure according to one further embodiment. An electrode structure is formed on the light-trimmed roughened layer 901 on the surface of substrate 90. The first blackened layer 924′ formed on the metal conductive layer 923′ is made by roughening its surface using etching or machining. That means the light-trimmed roughened structure is formed by directly machining the blackened layer. In which, the first blackened layer 924′ is formed on the metal conductive layer 923′ by means of electrolytic, sputtering, depositing, or coating. The first blackened layer 924′ with the surface texture is able to scatter the reflective lights made by the metal conductive layer 923′, and further suppress the quantity of the reflective lights.

Next, one further blackened layer such as the second blackened layer 925′ is formed upon the first blackened layer 924′ which already has roughened structure. This second blackened layer 925′ has its surface texture when it matches the surface structure of the first blackened layer 924′.

Reference next is made to FIG. 11. A first blackened layer 924″ formed on the metal conductive layer 923″ within the electrode structure remains unchanged, but directly etches or machines the second blackened layer 925″. The second blackened layer 925″ is therefore with its own surface structure. This second blackened layer 925″ is formed onto the first blackened layer 924″. The second blackened layer 925″ is utilized to scatter the reflective lights made by the metal conductive layer 923″. The quantity of reflective lights is as well reduced.

When manufacturing the two blackened layers, the first blackened layer 924″ may be formed on the conductive layer by the process of electrolytic, sputtering, depositing, or coating the materials. The second blackened layer 925″ may be made by performing electrolytic, sputtering, depositing, or coating process, and formed on the first blackened layer 924″.

The materials of the components within the electrode structure and the combination shown in FIG. 11 may be referred to above embodiments. The selection of materials, requirement of thickness and reflectivity may be referred to the above description.

Thus, the touch-sensitive panel device according to the disclosure includes at least one electrode structure with blackened layer rather than the disposal of blackened layer on a copper layer in the conventional technology. The stacked structure of the electrode structure allows suppressing the reflective lights made by the metal material and substrate, and significantly reducing thickness of the touch-sensitive panel. The structure does not increase haze of the light-transmissive section, and not affects conductivity of the metal layer. Meanwhile, it provides great weather resistance and good life at high temperature salt bath environment.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. An electrode structure, comprising:
a metal conductive layer being a conductive member of the electrode structure;
a light-trimmed roughened structure, formed upon the metal conductive layer within the electrode structure, wherein the light-trimmed roughened structure scatters the lights emitted to the electrode structure or the reflective lights made by the metal conductive layer; and further resists moire interference;
a first blackened layer, formed upon the light-trimmed roughened structure, used to absorb lights emitted to the electrode structure for eliminating reflective lights made by the metal conductive layer, so as to reduce color shift of a display screen;
a second blackened layer, formed upon the first blackened layer, used to enhance capability of resistance of corrosion, reducing color shift of the display screen, and level of blackening; a first adhesive layer formed between the metal conductive layer and a substrate; and the first adhesive layer is used to enhance adhesiveness between the electrode structure and the substrate when the electrode structure is combined with the substrate; and
a second adhesive layer between the first adhesive layer and the metal conductive layer for enhancing the adhesiveness there-between.

2. The structure of claim 1, wherein, when the light-trimmed roughened structure is continuously formed upon the metal conductive layer, the light-trimmed roughened structure is formed by etching or machining surface of the metal conductive layer; the light-trimmed roughened structure has the same material with the metal conductive layer.

3. The structure of claim 1, wherein, when the light-trimmed roughened structure is continuously formed upon the metal conductive layer, the light-trimmed roughened structure is formed as a light-trimmed roughened layer with surface texture on the metal conductive layer; material of the light-trimmed roughened structure is different from the metal conductive layer.

4. The structure of claim 1, wherein the first blackened layer or the second blackened layer has roughened surface with the light-trimmed roughened structure.

5. The structure of claim 4, wherein the first blackened layer or the second blackened layer is made by the material selected from copper, silver, aluminum, molybdenum, nickel, chromium, tungsten, titanium, silicon, zinc, tin, iron, and in combination thereof; thickness of the blackened layer or the another blackened layer is ranged from 0.001 um to 1 um; and reflectance of the blackened layer or the another blackened layer is between 1% and 50%.

6. The structure of claim 1, wherein the adhesive layer or the second adhesive layer is made by polymer, oxide, metal or in combination thereof; wherein, thickness of the adhesive layer or the second adhesive layer is ranged between 0.001 um and 1 um; and reflectance of the adhesive layer or the second adhesive layer is between 1% and 50%.

7. A panel device, comprising:
a substrate having at least one surface; and
one or more electrode structures formed on the surface of the substrate, wherein the electrode structure comprises:
a metal conductive layer being a conductive member of the electrode structure;
a light-trimmed roughened structure, formed upon the metal conductive layer within the electrode structure, wherein the light-trimmed roughened structure scatters the lights emitted to the electrode structure or the reflective lights made by the metal conductive layer; and further resists moire interference;
a first blackened layer, formed upon the light-trimmed roughened structure, used to absorb lights emitted to the electrode structure for eliminating reflective lights made by the metal conductive layer and reducing color shift of a display screen;
a second blackened layer, formed upon the first blackened layer, used to enhance capability of resistance of corrosion, reducing color shift of the display screen, and level of blackening;
a first adhesive layer formed between the metal conductive layer and a substrate; and the first adhesive layer is used to enhance adhesiveness between the electrode structure and the substrate when the electrode structure is combined with the substrate; and
a second adhesive layer between the first adhesive layer and the metal conductive layer for enhancing the adhesiveness there-between
